(19) United States
(12) Patent Application Publication
(10) Pub. No.: US 2008/0032838 A1
(43) Pub. Date: Feb. 7, 2008

(54) Pulley for a Belt Drive of a Vehicle

(76) Inventors: Marco Di Meco, Pescara (IT); Licinia Licini, Ortona (IT)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/596,840

(22) PCT Filed: May 19, 2004
(86) PCT No.: PCT/IT04/00285

§ 371 Date: Jul. 31, 2007

(51) Int. Cl. F16H 55/36

(52) U.S. Cl. 474/153

(57) ABSTRACT

Pulley for a belt drive of a vehicle including a hub revolving around an axis and able to be rigidly connected to a rotating shaft of an accessory cooperating with said transmission, a rim integral with the hub and having a multiplicity of circumferential ribs perpendicular to said axis able to cooperate with a belt of the belt drive. The pulley besides has a multiplicity of notches distributed circumferentially on lateral sides of the ribs.

### TECHNICAL FIELD

The present invention concerns an improved pulley for a belt drive of a vehicle.

### BACKGROUND ART

Generally, the accessories transmission of a motor vehicle includes a driving pulley rigidly connected to the driving shaft, a multiplicity of driven pulleys that drive respective accessories, among which an electric current generating machine, and a poli-V type drive belt wound around the pulleys to transmit the power necessary to drive the accessories.

Recently so-called ‘start-stop’ systems have been adopted that allow the automatic switching off and restarting of the internal combustion engine while the vehicle is stationary therefore reducing the polluting exhaust emissions particularly in urban areas.

For this purpose it is expedient to use an electric machine, i.e. which is capable of functioning as a generator of current and therefore be driven by the engine, as well as functioning as a motor for starting the internal combustion engine.

In particular, the starting by means of the reversible electric machine proves difficult in wet conditions and the known art of increasing the winding angle around the pulley of the reversible electric machine or of increasing the wedging between the belt and the pulley guarantee a much less reliable starting procedure besides causing noise and wear and tear of the transmission.

### DISCLOSURE OF INVENTION

The purpose of the present invention is to realize an improved pulley without the drawbacks described above.

A pulley is realized according to the present invention, like that defined in claim 1.

### BRIEF DESCRIPTION OF THE DRAWINGS

For a better understanding of the present invention some preferred embodiments are now described, purely by way of non-limiting example and with reference to the enclosed designs, in which:

FIG. 1 is a frontal view of a belt drive including a pulley according to the present invention;

FIG. 2 is a side view of a pulley according to the present invention;

FIG. 3 is a partially cutaway frontal view of the pulley of FIG. 2;

FIG. 4 is a section magnified according to the IV-IV line of FIG. 2 of a part.

FIG. 5 is a partially cutaway side view of a pulley according to an additional embodiment of the present invention; and

FIG. 6 is a section magnified according to the IV-IV line of FIG. 2 of a pulley according to a third embodiment of the present invention.

### BEST MODE FOR CARRYING OUT THE INVENTION

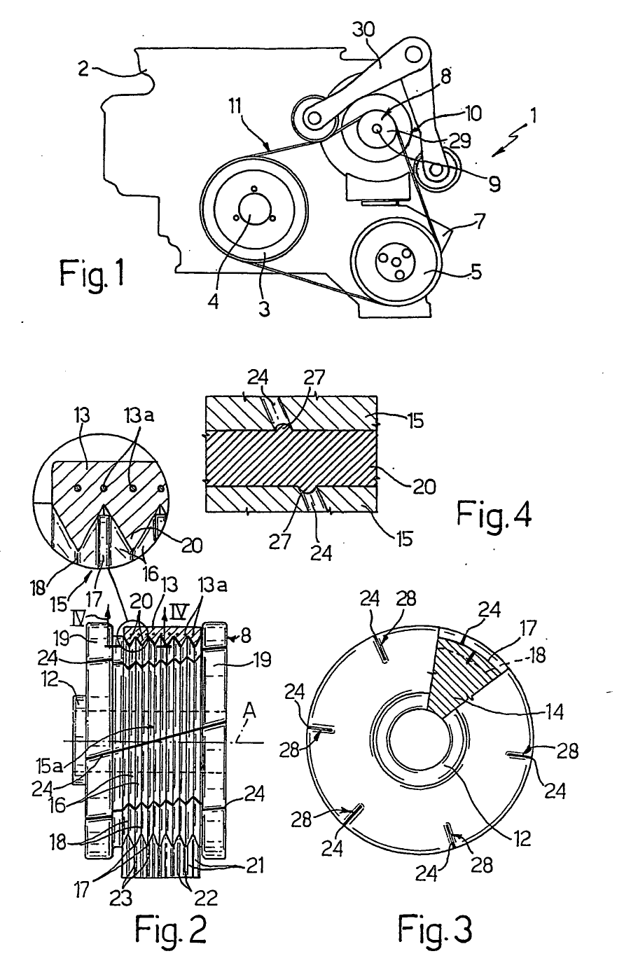

In FIG. 1 is denoted by 1, as a whole, an accessories transmission of an internal combustion engine 2 including a pulley 3 splined to a driving shaft 4 of the engine 2 and a driven pulley 5 able to drive a compressor 7 for an air conditioning unit.

The transmission 1 besides includes a pulley 8 rigidly connected to a rotating shaft 9 of a reversible electric machine 10, and a belt 11 of poli-V type including a body 13 of elastomeric material, wound around the pulley 3 and the pulleys 5 and 8 and kept taut by a twin-arm tensioner 30 to allow the transmission of power between the driving shaft 4, the compressor 7 and the reversible electric machine 10.

In particular, the body 13 is realized with a mixture for a back side, continuous polyester filiform stiffening elements 13a, and with a para-aramide felted mixture directly in contact with the pulleys 3, 5, 8.

The pulley 8 connected to the reversible electric machine 10 includes (FIG. 2) integrally a hub 12 splined to the shaft 9 having an axis A and a circular rim 14 integral with the hub 12.

The rim 14 includes a multiplicity of circular ribs 15 perpendicular to the axis A having a triangular radial section and each including one pair of flat sides 16 converging towards a radially peripheral crest 17 and joined to the respective sides 16 next to the neighbouring ribs 15 by means of a concave strip 18.

The ribs 15 therefore define a V-grooved surface 15a connected to the belt 11.

Besides, the ribs 15 are axially delimited by two edges 19 extending radially beyond the crests 17, and cooperate by friction with the back 13 of the belt 11 that is laterally guided by the edges 19 and has respective ribs 20 having sides 21, crests 22 and strips 23 functionally similar to those of the ribs 15 and having such dimensions so that contact occurs along the respective sides 16, 21 and between the crests 17 and the strips 23.

Besides, the rim 14 has six rectilinear grooves 24, circumferentially equidistant, which intersect at an angle of 30° as regards the axis A, the ribs 15 radially extending down below the strips 18 (FIG. 3) and thus defining a notch 26 both along the sides 26 as well as on the strips 18. In particular, the grooves 24 are parallel to each other and extend along the entire thickness of the rim 14 defining some evacuation ports 28 on respective faces 29 of the rim 14 disposed at opposite axial ends with respect to a median plane of the rim 14 perpendicular to the axis A. The operation of the pulley 8 is as follows.

When the belt 11 connects with the ribs 15 of the pulley 8, the respective sides 21 and 16 are in contact and the crests 22 of the belt 11 connect with the strips 18 of the pulley 8. Thanks to the tension maintained by the tensioner 30 and the pull of the transmission, the sides 16 and 21 are subjected to a contact pressure that tends to locally compress the elastomeric material of the belt 11. In this way, when a portion of the side 21 of a rib 20 of the belt 11 is facing a notch 26 it tends to expand elastically inside the same notch 26 causing the temporary formation of a transversal relief 27 (FIG. 4) that axially engages in the notch 26. Afterwards, when the portion of the side 21 disengages 11 from the pulley, the transversal relief 27 disappears thanks to the elastic recovery of the elastomeric material.

As a result, the motion is transferred in a hybrid way both through the friction between the respective flat portions of the sides 16 and 21 in contact with each other, as well as because of the engagement between the transversal reliefs 27 and the notches 26.

Therefore, during starting of the engine 2 in dry conditions the transfer of motion prevails through the friction of the sides 16 and 21, whereas during starting in wet conditions, the friction between the sides 16, 21 decreases and should the belt 11 show a tendency to slip however, it will be held by the transversal reliefs 27 that are engaged in the notches 26.

An examination of the characteristics of the pulley realized according to the present invention show the advantages that can be gained from it.

In particular, the engagement of the transversal reliefs 27 in the respective notches 26 improves the efficacy of the transfer of power between the belt 11 and the pulley 8, particularly in wet conditions. In fact since this method is unaffected by variations in the friction coefficient caused by the presence of water on the contact surfaces, it is possible to proportion and adapt the notches 26 and the relative grooves 24 so as to allow the transfer of the power necessary to start the engine.

Besides, the pulley 8 can connect with any type of poli-V belt since the formation of the transversal reliefs 27 inside the notches 26 is made possible thanks to the elasticity of the elastomeric material commonly used in the poli-V belts currently on the market.

The arrangement of the notches 26 along inclined courses as regards the axis A retains the elevated characteristic silence of transmissions which include a poli-V type belt.

Besides the presence of the evacuation ports 28 on the lateral faces allows the elimination of any excess moisture on the sides 16, 21 in contact.

Lastly it is clear that modifications and variations can be made to the system described herein, without leading away from the scope of the present invention, as defined in the enclosed claims.

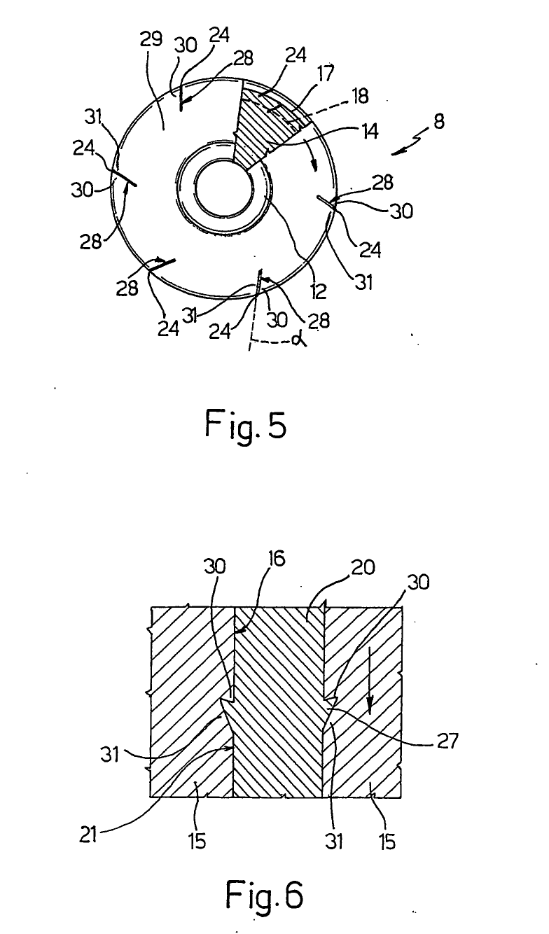

The grooves 24 can have both curvilinear as well as rectilinear courses being realized by a flat blade. In this case (FIG. 5), each groove 24 has a median plane a generally transversal both as regards the axis A as well as regards the tangent of each of the strips 18 crossed by the same groove 24.

In particular, when the median plane a is inclined in a direction facing the direction of movement of the pulley 8, each groove 24 is defined by a wedge portion 30 having an edge facing the direction of rotation of the pulley 8 and by a bevelled portion 31 of the rim 14 respectively facing said median plane α.

When the pulley 8 pulls the belt 11, the axial reliefs 27 interact mostly with the wedge portions 31 further improving the antislip effect.

Vice versa, when the belt 11 pulls the pulley 8, the axial reliefs 27 interact mostly with the bevelled portions 31 helping the release from the notches 26 and thus producing a basically unidirectional antislip system.

According to an additional embodiment, the notches 26 can be realized with different geometries, for instance they can be blind impressions.

FIG. 6 shows a partial development of a circumferential section depicting a pair of blind notches 26 engaged by respective axial reliefs 27.

Also in this case, each notch 26 is defined by a wedge portion 30 and by a bevelled portion 31 of the ribs 15 and the operation is similar to that previously described.

Besides, the sides 21 of the belt 11 can have raised fibres that constitute the drive of the felted mixture. The fibres engage in the notches 26 further increasing the efficacy of the torque transmission in wet conditions.

1. Pulley for a belt drive of a vehicle including a hub revolving around an axis and able to be rigidly connected to a rotating shaft of an accessory cooperating with said transmission, a rim integral with said hub and having a multiplicity of ribs circumferentially perpendicular to said axis and defining a V-grooved surface able to cooperate with a belt of said belt drive, characterized in that it has a multiplicity of notches spaced circumferentially on lateral sides of said ribs.

2. Pulley as claimed in claim 1, characterized in that said sides of neighbouring ribs are joined through respective concave strips and that said notches extend over said strips.

3. Pulley as claimed in one of the claim 1, characterized in that said notches are uniformly distributed.

4. Pulley as claimed in claim 1 characterized in that said notches follow courses disposed transversely as regards said ribs.

5. Pulley as claimed in claim 4, characterized in that said courses are rectilinear and oblique as regards said axis.

6. Pulley as claimed in claim 1, characterized in that said notches are realized by means of transversal grooves each passing through said ribs.

7. Pulley as claimed in claim 6, characterized in that it includes faces of axial ends and that said grooves extend axially between said faces.

8. Pulley as claimed in claim 1, characterized in that said multiplicity of notches is defined by a plurality of blind impressions.

9. Pulley as claimed in claim 1, characterized in that said pulley includes at least one wedge portion and at least one bevelled portion respectively facing and defining one of said notches.

10. Pulley as claimed in claim 9, characterized in that said at least one wedge portion is facing in a direction of rotation of said pulley.

11. (canceled)

11. Belt drive including at least one first and one second pulley rigidly connected to respective rotating shafts and respectively including a multiplicity of radially peripheral circumferential ribs and a belt wound under tension between said first and second pulley and including a body of elastomeric material connected to a V-grooved surface defined by said multiplicity of ribs, characterized in that said second pulley has a multiplicity of notches distributed circumferentially on the lateral sides of said ribs and housing respective reliefs of a portion said body in contact with said ribs said reliefs being elastically expanded inside said notches due to the effect of the tension of said belt.

13. Transmission as claimed in claim 11, characterized in that said belt includes a body having a felted mixture in contact with said second pulley.
